(19) United States
(12) Patent Application Publication
(10) Pub. No.: US 2025/0167253 A1
(43) Pub. Date: May 22, 2025

(54) GRAFTED CATALYST

(71) Applicant: Robert Bosch GmbH, Stuttgart (DE)

(72) Inventors: Nicola Molinari, Cambridge, MA (US); Karim Gadelrab, Wellesley, MA (US); Bjoern Stuehmeier, Santa Clara, CA (US); Felipe Mojica, Sunnyvale, CA (US)

(21) Appl. No.: 18/516,309

(22) Filed: Nov. 21, 2023

(51) Int. Cl. H01M 4/92; B82Y 15/00; H01M 4/02; H01M 4/90; H01M 8/1067

(52) U.S. Cl. CPC H01M 4/926; B82Y 15/00; H01M 4/9083; H01M 8/1067; H01M 2004/021

(57) ABSTRACT

Catalyst with ionomer-like polymeric chains grafted thereto are disclosed. The ionomer-like chains provide a reactant bridge for between the catalyst and ionomer such as in a fuel cell, especially when deposited in deep pores or cervices. In a refinement, the polymeric chains are deposited on less active facets of the catalyst.

### TECHNICAL FIELD

The present disclosure relates to catalyst for electrochemical cells. More specifically, grafting to the catalyst at less active areas may be particularly effective at enhancing catalyst efficiency and/or longevity.

### BACKGROUND

Electrochemical cells are of great importance in achieving a greener future that is less dependent on fossil fuels. However, significant improvements in electrochemical cells must be made before effective and viable alternatives to the overwhelming dependence on fossil fuels may be harnessed. Electrochemical cells may include catalyst, which is often one of the most expensive but critical components. Therefore, improving the efficiency of the catalyst is significant to achieving more viable electrochemical cells.

### SUMMARY

An electrochemical cell including a pair of electrodes (e.g., cathode and electrode), and a plurality of catalyst particles deposited on a catalyst support with each catalyst have a plurality of polymeric chains grafted thereto is disclosed. The plurality polymeric chains being grafted to a less active section or facet of the catalyst particles. The polymeric chains operating as a reactant bridge between the catalyst and ionomer.

A catalyst layer including a porous catalyst support, a catalyst deposited on the catalyst support, and a plurality of polymeric chains grafted to the catalyst, the plurality of polymeric chains including acid functional groups is disclosed.

A method of preparing a catalyst layer including providing a catalyst supported by a catalyst support and grafting polymeric chains to the catalyst is disclosed. The polymeric chains include ionic functional groups and are grafted to the catalyst at undercoordinated facets or atoms.

### BRIEF DESCRIPTION OF THE DRAWINGS

FIG. 1 is a schematic view of an embodiment of an electrochemical cell.

FIG. 2 is a schematic view of an embodiment of a catalyst composite/layer.

FIG. 3 is a perspective view of an embodiment of a grafted catalyst particle.

FIG. 4A is a view of a catalyst particle and FIG. 4B is a zoomed in partial view of an embodiment of a catalyst particle.

FIGS. 5A-C are perspective views of embodiments of catalyst with radical scavengers grafted thereon.

FIG. 6A is a top schematic view of an embodiment of a catalyst with polymeric grafting for steric hinderance.

FIG. 6B is a side schematic view a catalyst without polymeric grafting and steric hindrance.

FIG. 6C is a side schematic view of the embodiment of FIG. 6A.

FIG. 7 is a method of preparing a catalyst.

### DETAILED DESCRIPTION

Embodiments of the present disclosure are described herein. It is to be understood, however, that the disclosed embodiments are merely examples and other embodiments can take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art to variously employ the embodiments of the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Except in the examples, or where otherwise expressly indicated, all numerical quantities in this description indicating amounts of material or conditions of reaction and/or use are to be understood as modified by the word about in describing the broadest scope of the invention. Practice within the numerical limits stated is generally preferred. Also, unless expressly stated to the contrary: percent, “parts of,” and ratio values are by weight. The term “polymer” includes “oligomer,” “copolymer,” “terpolymer,” and the like. The description of a group or class of materials as suitable or preferred for given purpose in connection with the invention implies the mixtures of any two or more of the members of the group or class are equally suitable or preferred. Molecular weights provided for any polymers refers to number average molecular weight. Description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

This invention is not limited to the specific embodiments and methods described below, as specific components and/or conditions may vary. Furthermore, the terminology used herein is used only for the purpose of describing particular embodiments of the present invention and is not intended to be limiting in any way.

The term “substantially,” “generally,” or “about” may be used herein to describe disclosed or claimed embodiments. The terms “substantially,” “generally,” or “about” may modify a value or relative characteristic disclosed or claimed in the present disclosure to signify within manufacturing tolerances and/or within ±0%, 0.1%, 0.5%, 1%, 2%, 3%, 4%, 5% or 10% of the value or relative characteristic.

With respect to the terms “comprising,” “consisting of,” and “consisting essentially of,” where one of these three terms is used herein, the presently disclosed and claimed subject matter can include the use of either of the other two terms.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

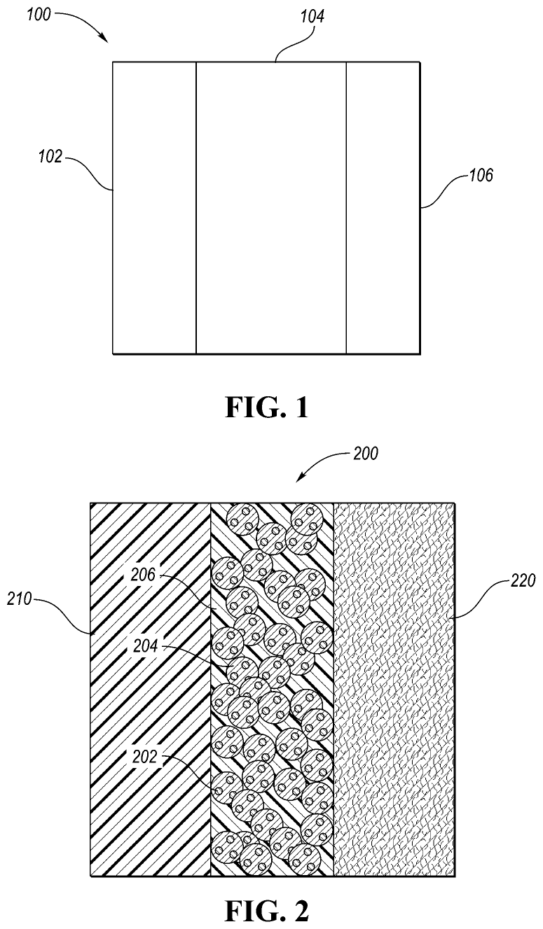

Referring to FIG. 1, electrochemical cell 100 (e.g., a fuel cell, flow battery, and/or electrolysis cell) includes at a plurality of electrodes (e.g., a first electrode 102 and a second electrode 106) and an electrolyte 104 disposed therebetween. Electrochemical cells generally induce desired chemical reactions with the assistance of a catalyst. For example, in a fuel cell, redox reactions are used to generate electricity-often with hydrogen and oxygen. In various embodiments, the first electrode 102 may, for example, be a cathode and the second electrode 106 may be an anode. In a refinement, the electrodes may be or include catalyst layers or composites. In some embodiments, the electrode may have a thickness of 0.5 to 500 μm, or more preferably 1 to 250 μm, or even more preferably 2 to 200 μm. For example, a fuel cell electrode may be 2-10 μm, an electrolysis electrode may be 2 to 10 μm, and a battery electrode may be 50-200 μm. In one or more embodiments, an electrochemical stack (not shown) may include a plurality of electrochemical cells. In various embodiments of the stack, the electrochemical cells may be arranged adjacent one another and in electrical communication. Each electrochemical cell or stack may further include one or more gas diffusion layers, one or more current collectors, one or more bipolar plates, and/or a separator.

Referring to FIG. 2, the catalyst layer or composite 200 may be adjacent electrolyte or ion conducting membrane 210 and gas diffusion layer 220 such as by being sandwiched or disposed therebetween. The catalyst layer or composite 200 may include a catalyst 202 supported by, deposited on, and/or embedded in a catalyst support 204. The catalyst 202 and catalyst support 204 may be in contact with and/or dispersed in or adjacent an ionomer 206. In one or more embodiments, the catalyst 202 is any suitable catalyst such as a metal (e.g., transition metal), alloy, oxide, or ceramic thereof (e.g., platinum, ruthenium, palladium, iron-nitrogen etc.). Conventionally catalyst efficiency has been improved merely by increasing the surface area to volume ratio. For example, in a fuel cell, the electrochemically active surface area (ECSA) is indicative of a cell's performance. Electrochemically active surfaces are in electrical communication with the current collector such as through the catalyst support but also must be accessible to the chemical reactants (e.g., hydrogen, oxygen, protons, and/or water). This support-catalyst-reactant interface may be a highly dynamic and chemically aggressive environment that raises challenges such as longevity for many components.

In various embodiments, catalyst nanoparticles (i.e., less than 100 nm) with a higher surface area to volume ratio may be used. For example, platinum nanoparticles may be used. Conventionally, the efficiency of such catalyst nanoparticles has focused on their arrangement on and/or in catalyst support.

In one or more embodiment, the catalyst support 204 is carbonaceous or a metal oxide. For example, the catalyst support 204 may be carbon black. Such supports may have catalyst embedded therein. For example, the catalyst support is often porous with deep crevices. The surface of such pores and crevices often includes catalyst that may be difficult to reach rendering the catalyst and cell less effective. This can be especially true for catalyst support particles with a greater porosity or a higher surface-area such as at least 400 m²/g, or at least 1,000 m²/g, or at least 1,600 m²/g (e.g., a greater surface area to volume ratio and/or a higher anchor point density), which may accommodate deeper pores and crevices. For example, medium (e.g., 400 to 1000 m²/g) or high (e.g., 800 m²/g or more) surface area carbon may suffer from such issues to a much greater extent than low surface area carbon (e.g., less than 400 m²/g). This situation is further exacerbated under dry conditions (e.g., an inlet relative humidity of 50% or less and/or a nominal relative humidity of 70% or less) where a polar or ionic solvent such as water is scarce because solvents such as water may facilitate reactant transport and/or conductivity.

In various embodiments, the ionomer 206 provides ionic conductivity. For example, the ionomer 206 may be an ion conducting polymer matrix. In one or more embodiments, the ionomer 206 includes ionic functional groups such as acids (e.g., carboxylic acid and/or sulfonic acid). For example, the equivalent weight with regards to the ionic functional groups such as sulfonic acid may be 500 to 2,000 g/mol, or more preferably 600 to 1,500 g/mol, or even more preferably 650 to 1,200 g/mol). In a variation, the ionomer 206 may have a thickness of 0.1 to 10 nm, or more preferably 0.5 to 7 nm, or even more preferably 1 to 5 nm. In some embodiments, the ionomer 206 is an ionic fluoropolymer such as Nafion® (e.g., a sulfonated tetrafluoroethylene-based fluoropolymer-copolymer). However, given the length and size of conventional ionomer polymeric chains the ionomer may be sterically hindered or otherwise have difficulty reaching all the catalyst, especially, such as in deep pores and crevices.

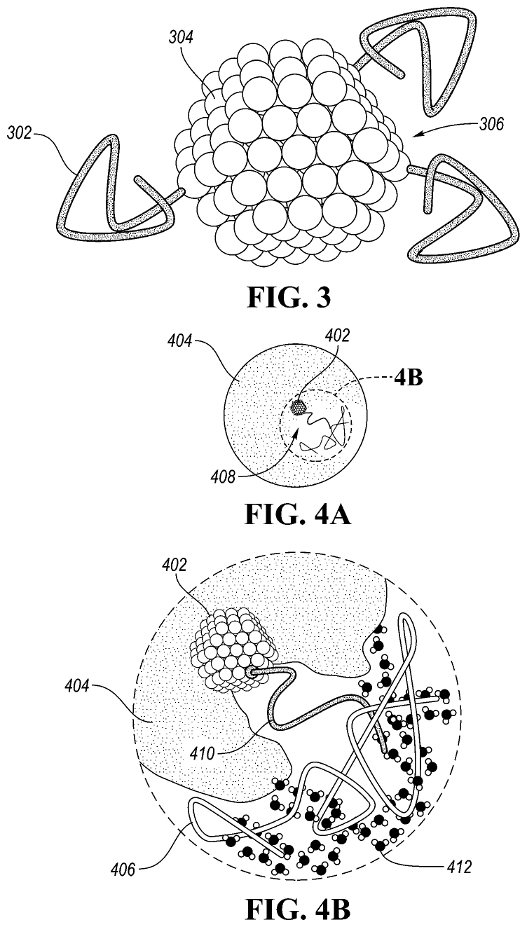

In numerous embodiments, one or more polymeric graft (i.e., polymer branches or chains) 302 may be grafted to the catalyst or catalyst support. For example, referring to FIG. 3, the polymeric graft units 302 may be grafted directly to the catalyst particle 304 or agglomerate 306. In one or more embodiments, the catalyst particle/agglomerate 304/306 may have areas (e.g., facets) of greater activity and areas (e.g., facets, edges, and/or corners) of less activity. For instance, various portions (e.g., facets, edges, and/or corners) of different crystalline structures have different activity. In one or more embodiments, the polymeric units 302 may be grafted to the areas with less activity. For example, the polymeric units may be grafted to corners, edges, or facets with less activity.

In various embodiments, the polymeric units 302 may be grafted to a regions/portion with undercoordination (e.g., under-coordinated atoms). In a refinement, the polymeric units 302 may be grafted to sites having a coordination number of no more than 8, or even more preferably no more than 7, or still even more preferably no more than 6. In various embodiments, the polymeric units 302 may not be grafted to areas having a coordination number of at least 7, or more preferably at least 8, or even more preferably at least 9. For example, the polymeric units may be grafted to the corner (e.g., coordination number of 5-6) and/or edges (e.g., coordination number of 7) of the catalyst particle/agglomeration 304/306. These regions such as corners and edges may also have less steric hindrance in many instances.

Numerous polymers may be grafted to the catalyst 304/306 to provide particular effects or enhancements. In various embodiments, the polymer 302 has a particular functionality correlated to its structure. For example, a polymer chain 302 may include more or less double bonds to reduce or enhance strength and/or stiffness, or may include particular functional groups (e.g., ionic groups) to provide specific characteristics. The grafted polymer 302 may have 10 to 500 repeating units, or more preferably 15 to 300 repeating units, or even more preferably 20 to 100 repeating units. The catalyst particle may have a grafting density of 2 to 20 polymer chains per catalyst particle 306, or more preferably 5 to 18 chains per catalyst particle 306, or even more preferably 10 to 17 chains per catalyst particle 306.

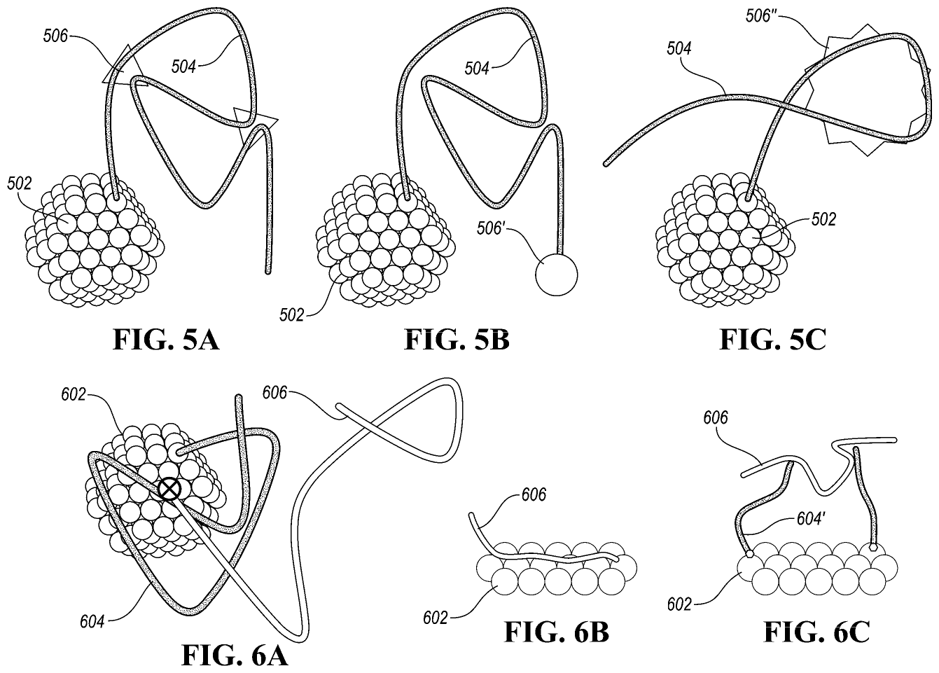

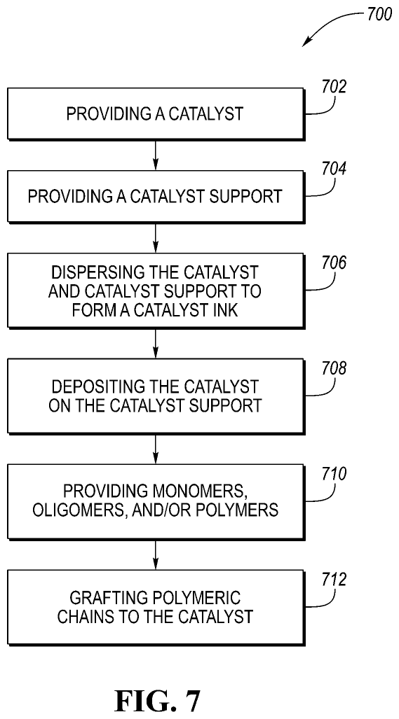

In one or more embodiments, one or more ionic polymeric units 406 (e.g., a plurality of ionic polymeric units), as shown in FIGS. 4A-B, may be grafted to the catalyst 402 or catalyst support 404 to enhance (ionic/electrical) conductivity (i.e., a reactant, ion, and/or conductive bridge between the catalyst and the ionomer) such as in dry conditions. In some embodiments, polymeric units with free radical scavenging capabilities 504 may be grafted to the catalyst 502, as shown in FIGS. 5A-5B, to localize free radical scavengers 506, 506′, 506″ where they are most needed and effective (i.e., eliminate or mitigate scavenger migration). In yet another example, polymeric units 604 may be grafted to the catalyst 602 to prevent catalyst poisoning such as by providing steric hindrance, as shown in FIGS. 6A and 6C.

The chemical reactions that drive electrochemical cells generally occur at the catalyst interface. For example, in a fuel cell, redox reactions (e.g., reduction at the cathode and oxidation at the anode) occur at the catalyst-ionomer interface because the ionomer 406 provides ionic conductivity (e.g., through protons). Water 412 and a wet environment may further facilitate ionic conductivity and reactant transport, especially in the absence of ionomer 406 or when small gaps between the catalyst 402 and the ionomer 406 exist. For example, the ionomer 406, which may have long polymer chains (e.g., 10⁴ da or more, 10⁵ da or more, or even 10⁶ or more), may have difficulty reaching catalyst active sites such as in pores and crevices 408 due to, for example, steric hindrance, as shown in FIG. 4A-4B.

However, under wet conditions these pores 408 may also be filled with water 412 such that ionic conductivity is maintained. But the amount of water available in a cell can fluctuate significantly based on numerous factors including the environment, the temperature, the nominal relative humidity, the age of the cell, how the cell is used, where the cell is used, and numerous other factors. Under dry conditions, the absence of water 412 may render certain catalyst sites less active or even inactive because of reduced ionic conductivity and reactant transport. During wet conditions, these small gaps may be occupied by water 412 and have greater ionic conductivity but during drier conditions water 412 migrates from these regions such that humidity changes may affect the efficiency and operation of the electrochemical cell. However grafting polymers with ionic functionality 410 to the catalyst 402 or catalyst support 404 (especially when grafted directly to the catalyst 402) may serve as a bridge to maintain reactions at the catalyst active sites despite reduced water levels or even in the absence of water 412. In variations, the polymeric grafted units 410 may be much smaller than conventional ionomer chains 406 such as Nafion®. For example, oligomers or smaller polymer chains may be used (e.g., 10,000 da or less, or more preferably 5,000 da or less, or even more preferably 1,000 da or less). In a refinement, the polymeric grafted unit 410 may have a molecular weight of 50,000 da or less, or more preferably 25,000 da or less, or even more preferably 20,000 da or less. In a variation, the polymeric graft units 410 may have a size (e.g., molecular weight or length) that is 75% or less than that of the ionomer chains 406 or side chains, or more preferably 50% or less, or even more preferably 25% or less.

In various embodiments, the polymeric graft unit or bridge 410 may include ionic functional groups such as acids (e.g., carboxylic acid and/or sulfonic acid groups). In a refinement, the equivalent weight relative to the ionic functional groups such as sulfonic acid may be 500 to 2,000 g/mol, or more preferably 600 to 1,500 g/mol, or even more preferably 650 to 1,200 g/mol. In a variation, the grafted polymeric units 410 may be more hydrophilic than the corresponding ionomer 406 (e.g., have a greater equivalent weight such as 800 g/mol, or more preferably 1,000 g/mol, or even more preferably 1,200 g/mol). In some embodiments, the polymeric graft unit or bridge 410 may have a fluoropolymer backbone or non-fluorinated polymer backbone such as a hydrocarbon backbone. For example, the grafted polymeric units 410 may be ionomer-like or Nafion®-like but smaller (i.e., smaller molecular weights and/or chain length)—shorter ionomer chains. In other words, ionomer-like or Nafion®-like may refer to using polymer chains of the same or similar chemical composition but smaller such as by molecular weight, chain length, or repeating units. For an ionomer-like chain may be at least 50% smaller by weight, length, or units, or more preferably at least 60% smaller, or even more preferably at least 75% smaller. For example, the grafted polymeric units 410 may have 10 to 500 repeating units, or more preferably 15 to 300 repeating units, or even more preferably 20 to 100 repeating units. In other words, the polymeric graft units 410 may be sulfonated tetrafluoroethylene-based fluoropolymer-copolymer.

Various grafting densities may be used. For example, grafting densities may be used to achieve a desired hydrophobicity or hydrophilic nature around the catalyst sites. For example, greater grafting densities may be desirable to provide a more hydrophilic environment around the catalyst that attracts water 412 and which facilitates reactant travel/delivery to the catalyst sites (e.g., enhances proton and/or oxygen diffusion). More hydrophilic environments may also better coordinate with water 412 to flood or fill such pathways during wetter conditions to further enhance efficiency. For example, a grafting density of 2 to 20 chains per catalyst particle 306, or more preferably 5 to 18 chains per catalyst particle 306, or even more preferably 10 to 17 chains per catalyst particle 306 may be used.

The dynamic and aggressive nature of the various chemical reactions that occur at the catalyst-ionomer interface is abundant with radical precursors and results in free radicals (e.g., ·OH), which can be destructive if unabated. For example, free radicals may jeopardize or reduce the stability of the ionomer. Conventionally, mobile free radical scavengers such as cerium ions (e.g., Ce³⁺) are used by adding/dispersing cerium oxide such as cerium oxide nanoparticles into the ionomer phase and/or proton exchange membrane (i.e., not proximate the catalyst). In other words, free radical scavengers are provided away from a primary source of the free radicals (i.e., the catalyst-reactant interface) and thus less effectively protect against free radicals. Further, even if sufficiently dispersed at initial stages of a cell's life, due to their mobility the free radical scavengers tend to migrate and accumulate in more polar regions such as wetter sections/regions of the cells-again away from a primary source of the free radicals. For example, the free radical scavengers such as cerium ions often drift with the flow of water to the proton exchange membrane and/or accumulate close to the outlet, which is minimally affected by free radicals such that once migration occurs such scavengers provide little to no benefit. These inhomogeneities in density and scavenging power are undesirable and inefficient.

In yet another embodiment, free radical scavengers 506, 506′, 506″ may be localized by the polymeric unit 504 grafted to the catalyst support or more preferably the catalyst 502, as shown in FIGS. 5A-C. In this way, the free radical scavengers 506, 506′, 506″ are proximate or near a primary source of free radicals for the most productive and efficient neutralization or to stabilize the free radicals. In various embodiments, polymeric graft unit 504 may be grafted to the catalyst 502 such as at a less active area/facet (e.g., corner or edge). The polymeric graft unit 504 may include one or more free radical scavenging functional groups or localize such free radical scavengers 506. For example, free radical scavengers 506 may be ionically bonded or form crosslinks 506 such as weak crosslinks throughout the polymer chains 504. In yet another example, free radical scavenging nanoparticles 506′ may be bonded to a terminal end of the polymer chains 504 opposite the catalyst 502 such as by covalent bonds. In still another embodiment, the free radical scavengers 506″ may form a portion of a complex, coordination compound, and/or a metal-organic framework 506″.

The polymeric backbone or scavenger scaffolding chain is not particularly limited and may be any suitable polymer. However, the polymeric units described herein such fluoropolymer and/or ethylene (e.g., a sulfonated tetrafluoroethylene-based fluoropolymer-copolymer) may be particularly useful. In a variation, the polymeric graft unit 506″ may be modified to and/or capable of complexing Ce³⁺ clusters or a coordination compound such as a metal organic framework containing Ce³⁺, i.e., the polymeric grafting units 504 includes coordinate/complexate radical scavengers.

In various embodiments, molecules, ions, compounds, or atoms capable of scavenging free radicals may serve as weak crosslinks 506, as shown in FIG. 5A. In some variations, small clusters or single atoms such as cerium ion clusters or cerium ions may weakly bind ionic groups such as sulfonate groups of the grafted polymeric units 504. The weak crosslinks 506 will detach or break away to scavenge free radicals. This technique mitigates or retards migration while still providing the benefits of a mobile free radical scavenger.

In one or more embodiments, one or more cerium particles 506′ such as cerium nanoparticles may be disposed on the polymer chain 504 such as proximate the terminal end of the grafted polymeric unit 504 opposite the catalyst 502, as shown in FIG. 5B. In a refinement, the cerium particle may form a bond (e.g., strong adsorption bond, electrostatic bond, hydrogen bridge, chelating bond, etc.) which may sever during operation of the electrochemical cell releasing the cerium nanoparticle. This at least temporarily immobilizes the free radical scavengers such that they cannot migrate and are localized proximate the catalyst. When the cerium is bonded directly to the polymeric grafts it ensures a minimum concentration of free radical scavenging amounts proximate the catalyst active sites.

In still other embodiments, grafted polymeric unit 504 may be or include a complex coordination compound and/or a metal organic framework (MOF) 506″. In variations, the MOF 506″ may include free radical scavengers such as cerium. The MOF 506″ may provide the correct oxidation for free radical scavengers such as cerium (III) ions (e.g., Ce³⁺) and more effectively provide free radical scavenging. Further, this strategy may also provide the minimal concentration of cerium.

In various embodiments, one or more of the above strategies may be combined they each provide unique benefits for localization and free radical scavenging.

In yet another embodiment, grafted polymeric units 604 may serve to protect the catalyst 602 such as from degradation or damage. For example, catalyst poisoning such as from common ionomers such as Nafion® is prevalent. Nafion® includes sulfonic acid groups that are capable of binding to the catalyst facets or surface and thus reduce or block the desired catalytic activity, which is often referred to as catalyst poisoning. As discussed above, the ionomer and catalyst often must be in close proximity to facilitate the desired catalyst-reactant interface and provide adequate reactant transport to the catalyst. However, this presents problems as over time the ionomer responsible for transporting such reactants may attack the catalyst reducing its efficiency.

In one or more embodiments, polymeric chains 604, 604′ may be grafted to the catalyst 602 to protect it from such reactions with the ionomer 606 or harmful functional groups thereof such as sulfonic acid groups thereon, as shown in FIGS. 6A and 6C. In various embodiments, the grafted polymer chains 604, 604′ may shield the catalyst 602 from the harmful functional groups such as from steric hindrance. For example, short and/or stiff polymeric chains 604′ may prevent the ionomer chains 606 from directly contacting the catalyst 602 as shown in FIG. 6C, whereas without such steric hindrance such ionomer branches 606 may freely come into contact with the catalyst surface such that the sulfonic acid groups may bind to the catalyst surface, as shown in FIG. 6B. In a refinement, these polymeric chains 604 may be stiff to provide better steric hindrance. In variations, the polymeric chains 604 may resist folding upon themselves such as from including a plurality of double bonds, including bulky functional groups such as cyclic rings (e.g., benzene rings) and/or form semicrystalline structures or crystalline domains within themselves or with adjacent chains. In a refinement, the polymeric chains may have a bending stiffness (kb) of at least 3, or more preferably at least 10, or even more preferably at least 25, or still even more preferably at least 50 In yet another example, the grafted polymeric chains 604′ may have a persistence length (Lₚ) of at least 4.5 Angstroms, or more preferably at least 5.0 Angstroms, or even more preferably at least 6.0 Angstroms, or still even more preferably at least 7.0 Angstroms or a Kuhn length of at least 8.0 Angstroms, or more preferably at least 8.5 Angstroms, or even more preferably at least 9.0 Angstroms. In a variation, using polymeric chains 604 having bulky functional groups such as cyclic rings (e.g., benzene rings) may provide suitable steric hindrance while reducing overall grafting density such that catalyst poisoning is reduced without significantly reducing catalytic activity. For example, polyethylene terephthalate and/or styrene polymeric chains may be grafted to the catalyst 602.

In one or more embodiments, a method 700 of preparing a catalyst and/or catalyst layer such as for an electrochemical cell is disclosed. The method includes providing a catalyst (i.e., step 702), providing a catalyst support (i.e., step 704), providing a monomer, oligomer, and/or polymer (i.e., step 710), depositing the catalyst onto a catalyst support (i.e., step 708), and forming or grafting polymeric units on the catalyst (i.e., step 712). In one or more embodiments, the catalyst and catalyst support may be dissolved and/or dispersed in a solvent to form a dispersion or ink. The mixture may further include a binder such as an ionomer binder. The solvent may be water and/or an organic solvent (e.g., an alcohol). In various embodiments, the mixture may be dried and shaped to form a composite or catalyst layer.

The catalyst may include platinum, platinum alloys, ruthenium, palladium, iron-nitrogen. In a refinement, catalyst nanoparticles may be used. In one or more embodiments, the catalyst nanoparticles are added to a catalyst ink or slurry (i.e., step 706) and precipitated out onto the catalyst support. In still other embodiments, catalyst precursors may be used. For example, H₂PtCl₆, K₂PtCl₄, K₂PtCl₆, Pt(NO₃)₄ or other platinum salts may be such as organic platinum precursor salts may be used. In various embodiments, other noble metal precursor materials may be used to graft such as by adding them to the grafting process to form platinum alloy catalyst. For example, platinum (II) (i.e., Pt²⁺) or platinum (IV) (i.e., Pt⁴⁺) may be used. The catalyst support may be carbonaceous such as carbon black or a metal oxide. In still other embodiments, commercial catalyst-catalyst support products such as platinum-carbon may be used.

The polymeric units may be grafted to the catalyst before being deposited on the support, or after being deposited on the support. In still other embodiments, the polymeric units may be formed or grown in solution and/or grafted simultaneously with deposition such as in the ink/slurry. Depending on the polymeric units used further steps may be necessary. For example, if a scavenger such as in the form of a coordination compound, complex, or weak crosslinks is incorporated in the polymeric grafting units a metal oxide powder such as cerium oxide may be added into the ink or added after the catalyst is deposited and the polymeric units are grafted. In yet another embodiment, the cerium oxide may be added into the ionomer such that when the catalyst layer and ionomer are assembled the cerium ions (Ce³⁺) are drawn to the catalyst and interact with the polymeric chains to keep the cerium ions scavengers localized around the catalyst.

While exemplary embodiments are described above, it is not intended that these embodiments describe all possible forms encompassed by the claims. The words used in the specification are words of description rather than limitation, and it is understood that various changes can be made without departing from the scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. An electrochemical cell comprising:
a pair of electrodes; and
a plurality of catalyst particles deposited on a catalyst support, each catalyst particle having sections with greater activity, sections with less activity, and polymeric chains grafted to the sections with less activity, the polymeric chains operating as a reactant bridge between the catalyst and an ionomer.

2. The electrochemical cell of claim 1, wherein the electrochemical cell is a fuel cell.

3. The electrochemical cell of claim 1, wherein the catalyst particles are nanoparticles.

4. The electrochemical cell of claim 1, wherein the catalyst particles have a grafting density of at least 2 to 20 chains per catalyst particle.

5. The electrochemical cell of claim 1, wherein the electrochemical cell is an electrolysis cell.

6. The electrochemical cell of claim 1, wherein the sections with less activity include corners and/or edges of the catalyst particle.

7. The electrochemical cell of claim 1, wherein the polymeric chains include acid functional groups.

8. The electrochemical cell of claim 1, wherein the polymeric chains include sulfonic acid groups.

9. A catalyst layer comprising:
a porous catalyst support;
a catalyst deposited on the porous catalyst support; and
a plurality of polymeric chains grafted to the catalyst, the plurality of polymeric chains including acid functional groups.

10. The catalyst layer of claim 9, wherein catalyst includes a plurality of less active facets and the plurality of polymeric chains are grafted to the plurality of less active facets.

11. The catalyst layer of claim 9, wherein the catalyst includes platinum.

12. The catalyst layer of claim 9, wherein the porous catalyst support is carbon black having a surface area of at least 400 m²/g.

13. The catalyst layer of claim 9, wherein, the porous catalyst support has a surface area of at least 800 m²/g.

14. The catalyst layer of claim 9, wherein the plurality of polymeric chains is sulfonated.

15. The catalyst layer of claim 9, wherein the plurality of polymeric chains includes sulfonated tetrafluoroethylene-based fluoropolymer.

16. The catalyst layer of claim 9, wherein the plurality of polymeric chains includes ionic functional groups.

17. A method of preparing a catalyst layer comprising:
providing a catalyst supported by a catalyst support; and
grafting polymeric chains having ionic functional groups to the catalyst at undercoordinated facets.

18. The method of claim 17, wherein the polymeric chains are grafted to the catalyst before its deposited on the catalyst support.

19. The method of claim 17, wherein the polymeric chains are grafted to the catalyst after its deposited on the catalyst support.

20. The method of claim 17, wherein catalyst is deposited on the catalyst support and simultaneously grafted with polymeric chains.
